(19) United States
(12) Patent Application Publication
(10) Pub. No.: US 2023/0161793 A1
(43) Pub. Date: May 25, 2023

(54) DATA SYNCHRONIZATION SYSTEM AND METHOD AND NON-TRANSITORY RECORDING MEDIUM

(71) Applicant: ADLINK TECHNOLOGY INC., Taoyuan City (TW)

(72) Inventors: CHEN-YING KUO, Taoyuan City (TW); YI-CHEN LIU, Taoyuan City (TW)

(21) Appl. No.: 17/700,542

(22) Filed: Mar. 22, 2022

(30) Foreign Application Priority Data
Nov. 25, 2021 (TW) 110143982

(51) Int. Cl. G06F 16/27; G06F 16/23

(52) U.S. Cl. CPC G06F 16/27; G06F 16/2379

(57) ABSTRACT

The present disclosure provides a data synchronization system, which is applicable to at least one autonomous mobile robot in a data distribution service domain, the at least one autonomous mobile robot includes a publisher, a subscriber and a data updating engine. The publisher takes a storing data stored in the autonomous mobile robot as a first updating data and publishes to a data synchronization topic. The subscriber subscribes to the data synchronization topic in the data distribution service domain, and when there is a second updating data for updating the storing data in the data synchronization topic, the second updating data is read. The data updating engine updates the storing data and maintains a modified recording list, the modified recording list is used to record a data modification record of the storing data. The present disclosure also provides a data synchronization method and a non-transitory recording medium.

### CROSS-REFERENCE TO RELATED APPLICATION

This non-provisional application claims priority under 35 U.S.C. 119(a) on Patent Application No(s). 110143982 filed in Taiwan, R.O.C. on Nov. 25, 2021, the entire contents of which are hereby incorporated by reference.

### BACKGROUND OF THE INVENTION

### 1. Field of the Invention

The present disclosure provides a data synchronization technology, especially a data synchronization system, a data synchronization method and a non-transitory recording device that are decentralized, and do not require a central control server.

### 2. Description of the Related Art

Autonomous Mobile Robots (AMRs) are becoming increasingly popular in vertical markets such as logistics, healthcare, agriculture and mining. In addition, as labor costs increase, the development and introduction of robotic systems will be further emphasized in the future to perform repetitive work.

In a workplace, multiple autonomous mobile robots are often set up, which are connected to each other via a network and controlled by a central control server to complete tasks. For example, as to autonomous mobile robots for handling, each autonomous mobile robot is installed with a map of the plant to avoid collision with obstacles, and when the location of the machines in the plant changes, the current method is that each autonomous mobile robot respectively performs data synchronization by the central control server.

### BRIEF SUMMARY OF THE INVENTION

The inventor exhausted his mind to research carefully, and then developed a data synchronization system, a data synchronization method and a non-transitory recording device, in order to achieve decentralization, and do not require a central control server for the purpose of data synchronization.

A first aspect of the present disclosure provides a data synchronization system, which is applicable to at least one autonomous mobile robot in a data distribution service domain, the at least one autonomous mobile robot comprises a publisher, a subscriber and a data updating engine. The publisher is configured to take a storing data stored in the autonomous mobile robot as a first updating data and publishes to a data synchronization topic. The subscriber is used to subscribe to the data synchronization topic in the data distribution service domain, and when there is a second updating data in the data synchronization topic, the second updating data is read from the data synchronization topic. The data updating engine is used to update the storing data and maintains a modified recording list, and the modified recording list is used to record a data modification record of the storing data.

A second aspect of the present disclosure provides a data synchronization method, which is applicable to the autonomous mobile robot in the data distribution service domain, the data synchronization method comprises the following steps: allowing the at least one autonomous mobile robot to subscribe to a data synchronization topic in the data distribution service domain, thereby taking a storing data in the autonomous mobile robot as a first updating data and publishing to a data synchronization topic, and when there is a second updating data in the data synchronization topic, the autonomous mobile robot reads the second updating data from the data synchronization topic; and after updating the storing data, recording a modification record of the storing data by a modified recording list.

A third aspect of the present disclosure provides a non-transitory recording medium, which stores a plurality of program instructions, so that after the at least one autonomous mobile robot in the data distribution service domain executes the program instructions, the following steps can be executed: allowing the at least one autonomous mobile robot to subscribe to a data synchronization topic in the data distribution service domain, thereby taking a storing data in the autonomous mobile robot as a first updating data and publishing to a data synchronization topic; providing a subscriber, the subscriber subscribes to a data synchronization topic in the data distribution service domain; when there is a second updating data in the data synchronization topic, the autonomous mobile robot reads the second updating data from the data synchronization topic; and after updating the storing data, recording a modification record of the storing data by a modified recording list.

In an embodiment, the first updating data and the second updating data respectively have an updating timestamp, and the data updating engine is further used to determine whether the content of the first updating data and that of the second updating data overlap, when the content of the first updating data and that of the second updating data fail to overlap, the data updating engine maintains the data modification record in the modified recording list according to the chronological order of the updating timestamps.

In an embodiment, when the content of the first updating data and that of the second updating data partially or completely overlap, the data updating engine selects the first updating data and the second updating data which one has an earlier modification timestamp to update the storing data.

In an embodiment, when the data updating engine selects the one having the earlier modification timestamp to update the storing data, while issuing a conflict notification to an upper management.

Therefore, the data synchronization system, the data synchronization method and non-transitory recording medium of the present disclosure can achieve decentralization, do not require a central control server for the purpose of data synchronization, because a plurality of autonomous mobile robots thereamong can perform data synchronization by the data distribution service.

### BRIEF DESCRIPTION OF THE DRAWINGS

FIG. 1 is a schematic block diagram 1 of a data synchronization system configured for an autonomous mobile robot according to an embodiment of the present disclosure.

FIG. 2 is a schematic flow chart of a data synchronization method according to the embodiment of the present disclosure.

FIG. 3 is a schematic block diagram 2 of the data synchronization system configured for the autonomous mobile robot according to an embodiment of the present disclosure.

FIG. 4 is a schematic view of a plurality of autonomous mobile robot systems performing data synchronization corresponding to FIG. 3.

FIG. 5 is a schematic block diagram 3 of the data synchronization system configured for the autonomous mobile robot according to an embodiment of the present disclosure.

FIG. 6 is a schematic view of a plurality of autonomous mobile robot systems performing data synchronization corresponding to FIG. 5.

FIG. 7 is a schematic block diagram 4 of the data synchronization system configured for the autonomous mobile robot according to an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided. The description is provided as follows:

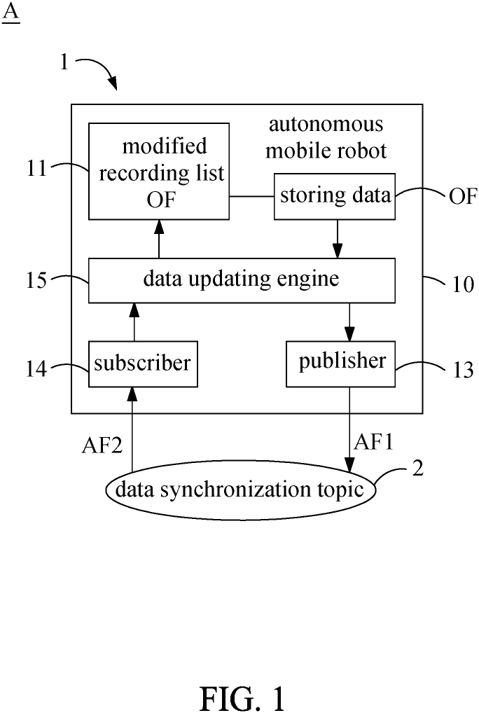

Referring to FIG. 1, a first aspect of the present disclosure provides a data synchronization system 1, which is applicable to an autonomous mobile robot (AMR) 10 in a data distribution service (DDS) domain A, the autonomous mobile robot 10 comprises a publisher 13, a subscriber 14 and a data updating engine 15. The publisher 13 is configured to take a storing data OF stored in the autonomous mobile robot 10 as a first updating data AF1 and publishes to a data synchronization topic 2. The subscriber 14 is used to subscribe to the data synchronization topic 2 in the data distribution service domain A, and when there is a second updating data AF2 in the data synchronization topic 2, the second updating data AF2 is read from the data synchronization topic 2. The data updating engine 15 is used to update the storing data OF and maintains a modified recording list 11, and the modified recording list 11 is used to record a data modification record of the storing data OF. The data used for the data synchronization system 1 of the present disclosure may be archives, folders or programs.

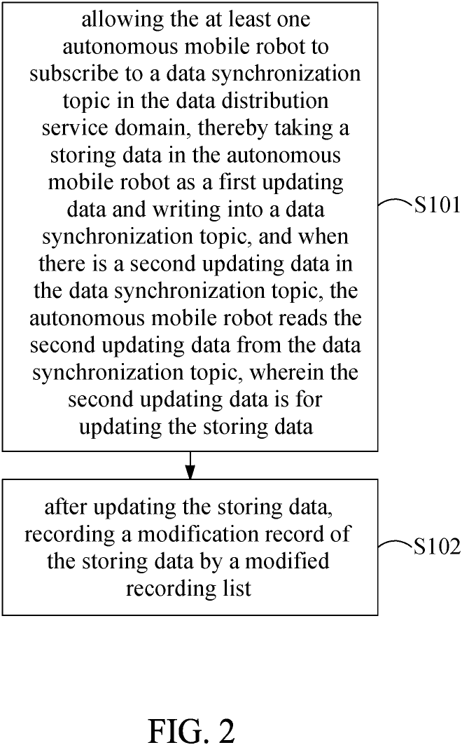

Referring to FIGS. 1 and 2, a second aspect of the present disclosure provides a data synchronization method, which is applicable to the autonomous mobile robot 10 in the data distribution service domain A, the data synchronization method comprises the following steps:
Step S101: allowing the at least one autonomous mobile robot 10 to subscribe to a data synchronization topic in the data distribution service domain A, thereby taking a storing data OF in the autonomous mobile robot 10 as a first updating data AF1 and publishing to a data synchronization topic 2, when there is a second updating data AF2 in the data synchronization topic 2, the autonomous mobile robot 10 reads the second updating data AF2 from the data synchronization topic 2; and
Step S102: after updating the storing data OF, recording a modification record of the storing data OF by a modified recording list 11.

Referring to FIGS. 1 and 2, a third aspect of the present disclosure provides a non-transitory recording medium, which stores a plurality of program instructions, so that after the at least one autonomous mobile robot 10 in the data distribution service domain A executes the program instructions, the following steps can be executed: allowing the at least one autonomous mobile robot 10 to subscribe to a data synchronization topic 2 in the data distribution service domain A, thereby taking a storing data OF in the autonomous mobile robot 10 as a first updating data AF1 and publishing to a data synchronization topic; providing a subscriber 14, the subscriber 14 subscribes to a data synchronization topic 2 in the data distribution service domain A; when there is a second updating data AF2 in the data synchronization topic 2, the autonomous mobile robot 10 reads the second updating data AF2 from the data synchronization topic 2; and after updating the storing data OF, recording a modification record of the storing data OF by a modified recording list 11. The non-transitory recording medium may be a disc, memory card, portable hard drive, or other computer-readable device.

As mentioned above, the data synchronization system 1, the data synchronization method and non-transitory recording medium of the present disclosure can achieve decentralization, do not require a central control server for the purpose of data synchronization, because a plurality of autonomous mobile robots 10 thereamong can perform data synchronization by the data distribution service.

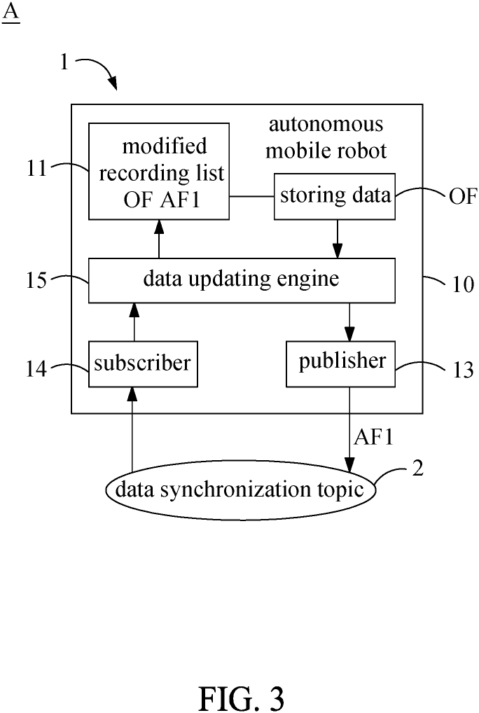

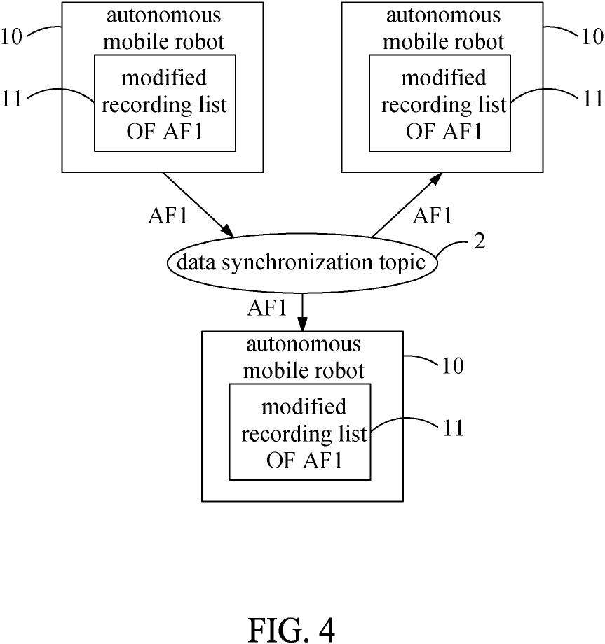

Referring to FIGS. 3 and 4, a plurality of nodes of the data distribution service domain A can be respectively equipped with an autonomous mobile robot 10, if one of the autonomous mobile robots 10 takes the storing data OF as the first updating data AF1, the publisher 13 will publish the first updating data AF1 to the data synchronization topic 2, and synchronize to all the autonomous mobile robots 10. In addition, each autonomous mobile robot 10 will also record a modified history of the data in the modified recording list 11. Each autonomous mobile robot 10 is installed with the data synchronization system 1, there is no master-slave relation among each other, and there is no need to set up an additional central control server for control. The data synchronization system 1 may be software, and the publisher 13, the subscriber 14, the data updating engine 15 and the data synchronization topic 2 may be program instructions in the software. The storing data OF and the modified recording list 11 are the computer-readable and modified data. The data updating engine 15 is coupled with the subscriber 14 and the publisher 13 to update the storing data OF using the second updating data AF2 through the subscriber 14, and the first updating data AF1 is published to the data synchronization topic 2 through the publisher 13. The storing data OF may be a map file, each autonomous mobile robot 10 can be equipped with lasers, cameras and built-in sensors to detect obstacles in real time and update the map file through the publisher 13 and the data updating engine 15, when any autonomous mobile robot 10 updates the map file, the other autonomous mobile robots 10 can also synchronously update the map file through peer-to-peer communication because of subscribing to the data synchronization topic 2.

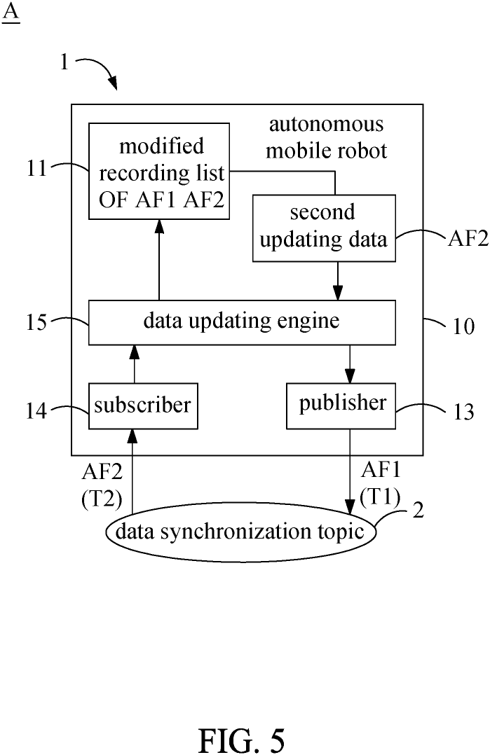

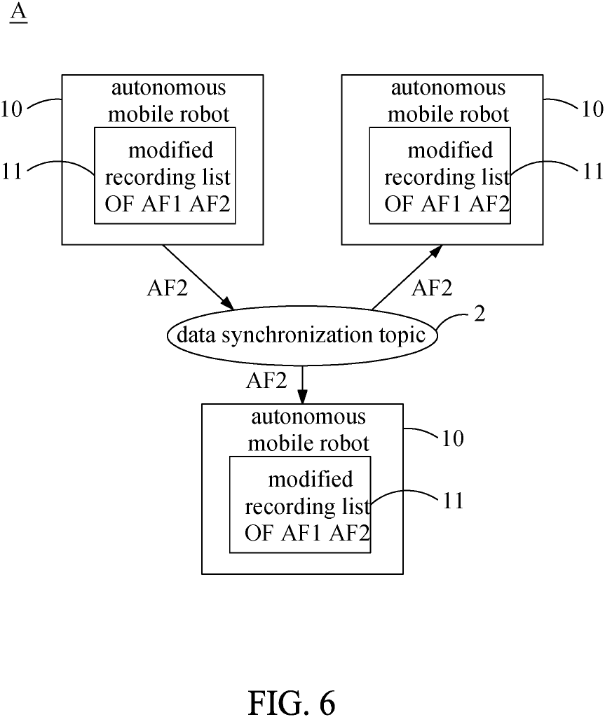

Referring to FIGS. 5 and 6, in the embodiment, the first updating data AF1 and the second updating data AF2 respectively have an updating timestamp T1 and an updating timestamp T2. The data updating engine 15 is further used to determine whether the content of the first updating data AF1 and that of the second updating data AF2 overlap, when the content of the first updating data AF1 and that of the second updating data AF2 fail to overlap, the data updating engine 15 maintains the data modification record in the modified recording list 11 according to the chronological order of the updating timestamps. In FIGS. 5 and 6, the content of the first updating data AF1 fails to overlap with that of the second updating data AF2, and the order of timestamp T1 of the first updating data AF1 is earlier than that of the timestamp T2 of the second updating data AF2, so the data updating engine 15 first records the first updating data AF1, and then records the second updating data AF2 in the modified recording list 11 according to the chronological order of the updating timestamps, and updates data to all the autonomous mobile robots 10 by the second updating data AF2.

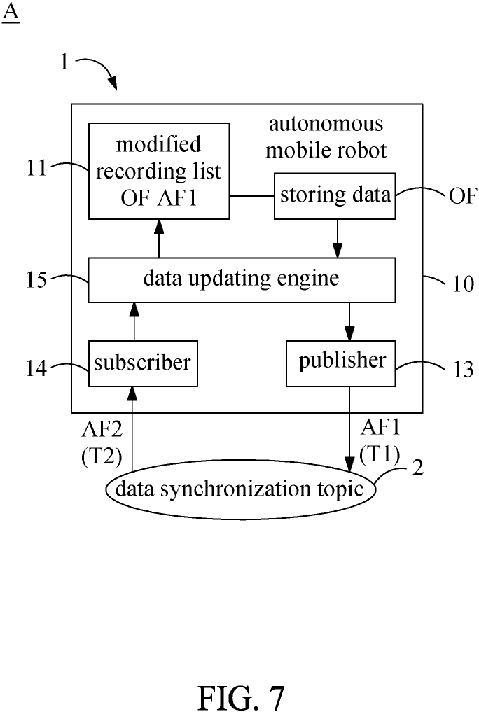

As shown in FIG. 7, in an embodiment, when the content of the first updating data AF1 and that of the second updating data AF2 partially or completely overlap, the data updating engine 15 selects the first updating data AF1 and the second updating data AF2 which one has an earlier modification timestamp to update the storing data OF, while issuing a conflict notification to an upper management. For example, the updating timestamp T1 of the first updating data AF1 is earlier than the updating timestamp T2 of the second updating data AF2, and the two overlap, at this point the data updating engine 15 retains only the first updating data AF1, ignores the second updating data AF2 received, and issues a conflict notification to the upper management. Conversely, if the updating timestamp T2 of the second updating data AF2 is earlier than the updating timestamp T1 of the first updating data AF1, and the two overlap, at this point the data updating engine 15 will retain the second updating data AF2 and discard the first updating data AF1, while notifying the upper management to resolve the conflict (not shown in figures).

While the present disclosure has been described by means of specific embodiments, those skilled in the art should understand the above description is merely embodiments of the disclosure, and it should not be considered to limit the scope of the disclosure. It should be noted that all changes and substitutions which come within the meaning and range of equivalency of the embodiments are intended to be embraced in the scope of the disclosure. Therefore, the scope of the disclosure is defined by the claims.

What is claimed is:

1. A data synchronization system, which is applicable to at least one autonomous mobile robot in a data distribution service domain, the at least one autonomous mobile robot comprising:
a publisher, configured to take a storing data stored in the autonomous mobile robot as a first updating data and publishes to a data synchronization topic;
a subscriber, configured to subscribe to the data synchronization topic in the data distribution service domain, and when there is a second updating data in the data synchronization topic, the second updating data is read from the data synchronization topic; and
a data updating engine, configured to update the storing data and maintains a modified recording list, and the modified recording list is used to record a data modification record of the storing data.

2. The data synchronization system according to claim 1, wherein the first updating data and the second updating data respectively have an updating timestamp, and the data updating engine is further used to determine whether the content of the first updating data and that of the second updating data overlap, when the content of the first updating data and that of the second updating data fail to overlap, the data updating engine maintains the data modification record in the modified recording list according to the chronological order of the updating timestamps.

3. The data synchronization system according to claim 2, wherein when the content of the first updating data and that of the second updating data partially or completely overlap, the data updating engine selects the first updating data and the second updating data which one has an earlier modification timestamp to update the storing data.

4. The data synchronization system according to claim 3, wherein when the data updating engine selects the one having the earlier modification timestamp to update the storing data, while issuing a conflict notification to an upper management.

5. A data synchronization method, which is applicable to at least one autonomous mobile robot in a data distribution service domain, the data synchronization method comprising the following steps:
allowing the at least one autonomous mobile robot to subscribe to a data synchronization topic in the data distribution service domain, thereby taking a storing data in the autonomous mobile robot as a first updating data and publishing to a data synchronization topic, when there is a second updating data in the data synchronization topic, the autonomous mobile robot reads the second updating data from the data synchronization topic; and
after updating the storing data, recording a modification record of the storing data by a modified recording list.

6. The data synchronization method according to claim 5, wherein the first updating data and the second updating data respectively have an updating timestamp, and the data updating engine is further used to determine whether the content of the first updating data and that of the second updating data overlap, when the content of the first updating data and that of the second updating data fail to overlap, the data updating engine maintains the data modification record in the modified recording list according to the chronological order of the updating timestamps.

7. The data synchronization method according to claim 6, wherein when the content of the first updating data and that of the second updating data partially or completely overlap, the data updating engine selects the first updating data and the second updating data which one has an earlier modification timestamp to update the storing data.

8. The data synchronization method according to claim 7, wherein when the data updating engine selects the one having the earlier modification timestamp to update the storing data, while issuing a conflict notification to an upper management.

9. A non-transitory recording medium, which stores a plurality of program instructions, so that after the at least one autonomous mobile robot in the data distribution service domain executes the program instructions, the following steps can be executed:
allowing the at least one autonomous mobile robot to subscribe to a data synchronization topic in the data distribution service domain, thereby taking a storing data in the autonomous mobile robot as a first updating data and publishing to a data synchronization topic;
providing a subscriber, the subscriber subscribes to a data synchronization topic in the data distribution service domain;
when there is a second updating data in the data synchronization topic, the autonomous mobile robot reads the second updating data from the data synchronization topic; and
after updating the storing data, recording a modification record of the storing data by a modified recording list.

10. The non-transitory recording medium according to claim 9, wherein the first updating data and the second updating data respectively have an updating timestamp, and the data updating engine is further used to determine whether the content of the first updating data and that of the second updating data overlap, when the content of the first updating data and that of the second updating data fail to overlap, the data updating engine maintains the data modification record in the modified recording list according to the chronological order of the updating timestamps.

11. The non-transitory recording medium according to claim 10, wherein when the content of the first updating data and that of the second updating data partially or completely overlap, the data updating engine selects the first updating data and the second updating data which one has an earlier modification timestamp to update the storing data.

12. The non-transitory recording medium according to claim 11, wherein when the data updating engine selects the one having the earlier modification timestamp to update the storing data, while issuing a conflict notification to an upper management.
